(19) United States
(12) Patent Application Publication
(10) Pub. No.: US 2019/0101996 A1
(43) Pub. Date: Apr. 4, 2019

(54) METHODS AND APPARATUS TO DETECT TOUCH INPUT GESTURES

(71) Applicant: Intel Corporation, Santa Clara, CA (US)

(72) Inventor: Sean Lawrence, Bangalore (IN)

(21) Appl. No.: 16/136,244

(22) Filed: Sep. 19, 2018

(30) Foreign Application Priority Data
Sep. 29, 2017 (IN) 201741034697

(51) Int. Cl. G06F 3/0354; G06F 3/01; G06F 3/041

(52) U.S. Cl. CPC G06F 3/03547; G06F 3/041; G06F 3/017

(57) ABSTRACT

Methods and apparatus to detect touch input gestures are disclosed. An example apparatus includes a touch sensitive display, a touch sensor to detect touches and hovers associated with the touch sensitive display, and a gesture handler including: an identifier to identify fingers associated with the touches and hovers, and a gesture detector to determine a gesture associated with the touches and hovers and determine an action associated with the gesture and the identified fingers.

### RELATED APPLICATIONS

This patent claims the benefit of Indian Patent Application No. 201741034697, filed Sep. 29, 2017, entitled “METHODS AND APPARATUS TO DETECT TOUCH INPUT GESTURES,” which is hereby incorporated herein by reference in its entirety.

### FIELD OF THE DISCLOSURE

This disclosure relates generally to touch input, and, more particularly, to methods and apparatus to detect touch input gestures.

### BACKGROUND

In recent years, touch input devices, such as touch sensing displays, have increased in quality and popularity. For example, many popular computing devices such as laptop computers, desktop computers, tablet computers, smartphones, etc. have been implemented with touch input devices to accept user input via touch (e.g., via a finger touching the display). Some such touch input devices are capable of sensing multiple touch inputs (e.g., a two-finger input gesture). Additionally or alternatively, some touch input devices are capable of detecting touch input prior to/without the touch input making contact with the touch input device. This type of detection is commonly referred to as hover detection (e.g., detecting a finger that is hovering and/or approaching the touch input device).

### BRIEF DESCRIPTION OF THE DRAWINGS

FIG. 1 is a block diagram of an example touch input device.

FIG. 2 is a block diagram of an example implementation of a gesture handler.

FIGS. 3-4 are flowcharts representative of machine readable instructions which may be executed to implement an example gesture detector.

FIG. 5 is a block diagram of an example processing platform capable of executing the instructions of FIGS. 3-4 to implement a gesture detector.

The figures are not to scale. Wherever possible, the same reference numbers will be used throughout the drawing(s) and accompanying written description to refer to the same or like parts.

### DETAILED DESCRIPTION

Methods and apparatus disclosed herein utilize hover detection and/or touch input detection to identify a finger or fingers that are performing a touch input gesture on a touch input device. For example, the disclosed methods and apparatus determine which of the five fingers of an example hand have made contact with the touch input device. As disclosed herein, the finger(s) are identified by detecting the fingers in contact with and hovering over the touch input device. For example, the finger(s) may be detected by analyzing patterns of finger position (e.g., detecting four hovering fingers and one finger in contact with the touch input device along with the relative positions of the five fingers) to detect a particular finger(s) of a hand and/or detect which hand is utilized (e.g., left hand and/or right hand). The disclosed methods and apparatus trigger finger-specific actions based on the identified finger(s). For example, touching a button with a pointer finger may trigger a different action than touching a finger with a thumb.

For clarity, throughout fingers of a hand will be referred to as fingers 1 to 5 counting starting from the thumb.

In some disclosed examples, different resultant actions are assigned to gestures performed using different fingers.

In some examples, performing a pinch-in using finger 1 and finger 2 causes zooming in, performing a pinch-out using finger 1 and finger 2 causes zooming out, performing a pinch-in using finger 1 and finger 3 causes an application to be minimized, and performing a pinch-out using finger 1 and finger 3 causes an application to be maximized.

In some examples, tapping the screen with finger 2 triggers a left click action (e.g., the same action as clicking the left button of a mouse) and tapping the screen with finger 3 triggers are right click action.

In some examples, in an application that supports drawing, underlining, highlighting, handwriting, etc., different fingers may be associated with different colors (e.g., dragging with finger 2 creates a red line and dragging with finger 3 creates a blue line), different line formats (e.g., line weights, dashed lines vs. solid lines, etc.), use of different drawing tools, etc.

In some examples, multiple screens may be linked and a flick of one finger on an icon or widget may have the program open up on a different screen in the direction of the flick. Another finger may be used to send the program or data to the Recycle bin.

In some examples, touching a screen with different fingers (e.g., increasing from fingers 1 to 5 or decreasing from fingers 5 to 1, or any subset of increasing or decreasing) can trigger increasing a value or decreasing a value (e.g., increasing/decreasing a system setting such as volume or brightness, incrementing/decrementing a number, etc. For example, a single tap with finger 2 of the right hand may increase the volume by 5 units. A tap of finger 2 of the left hand may increase the brightness by 5 units. A tap with finger 3 on either hand may increase the respective property by 10 units and so on.

The identification of particular example fingers throughout the disclosure is to provide examples and is not intended to be limiting to specific fingers unless specific fingers are identified in the claims. The disclosed gestures may be associated with any particular finger and/or combination of fingers.

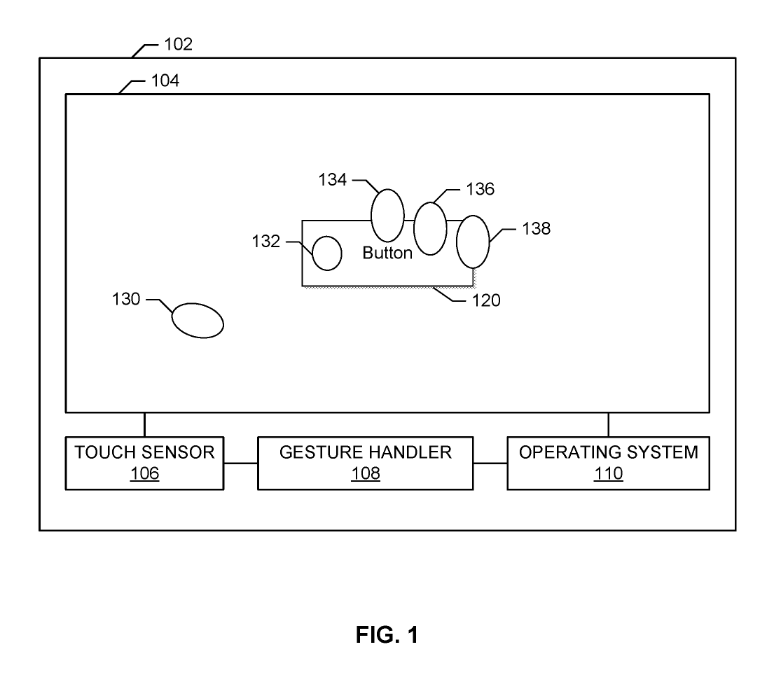

FIG. 1 is a block diagram of an example touch input device 102. According to the illustrated example, the touch input device 102 is a tablet computing device. Alternatively, the touch input device 102 may be any type of device that supports touch input (e.g., a laptop computer, a desktop computer monitor, a smartphone, a kiosk display, a smart whiteboard, etc.). The example touch input device 102 includes an example touch sensitive display 104, an example touch sensor 106, an example gesture handler 108, and an example operating system 110.

The example touch sensitive display 104 is a display that is coupled with a capacitive touch sensing circuitry to detect touches (e.g., inputs that make contact with the touch sensitive display 104) and hovers (e.g., inputs such as fingers that are proximate the touch sensitive display 104 but are not in contact with the touch sensitive display 104). Alternatively, any other type of display and/or touch sensing that can detect touches and hovers may be utilized.

The touch circuitry of the example touch sensitive display 104 is communicatively coupled to a touch sensor 106. The example touch sensor 106 processes the signals from the touch circuitry to determine the characteristics of touches and hovers. For example, the touch sensor 106 determines the size of a touch and/or hover (e.g., a footprint of the touch/hover on the touch sensitive display 104), the location of a touch/hover within the boundaries of the touch sensitive display 104, an intensity of the touch/hover (e.g., how hard a touch is pressing on the touch sensitive display 104, how close a hover is to the touch sensitive display 104, etc.). The touch sensor 106 transmits characteristics about touches/hovers to the example gesture handler 108.

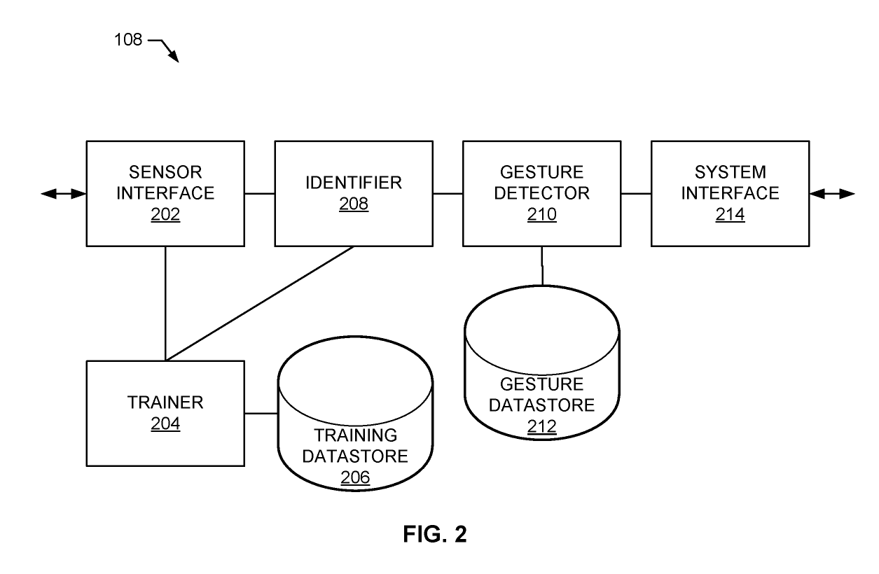

The gesture handler 108 of the illustrated example analyzes the characteristics of touches/hovers received from the example touch sensor 106 over time to detect gestures and trigger actions associated with the gestures. In particular, the example gesture handler 108 analyzes the characteristics of touches/hovers to identify a finger(s) performing the touches/gestures and triggers actions that are associated with the combination of gesture and finger(s). Further detail for triggering action(s) is described in conjunction with FIG. 2. The example gesture handler 108 transmits an indication of the action to be performed to the example operating system 110.

The example operating system 110 is the executing software and/or circuitry that interfaces software executing at the touch input device 102 with hardware of the touch input device 102 and/or other software executing on the touch input device 102. The actions triggered by the example gesture handler 108 are passed to a particular application (e.g., if the gesture is associated with a particular application) and/or are handled by the operating system 110 (e.g., if the gesture is associated with the operating system 110 or is otherwise not associated with an application).

For descriptive purposes, FIG. 1 includes a displayed button 120. The example button 120 is representative of elements that may be displayed on the touch sensitive display 104. Alternatively, the displayed button 120 may be replaced with any number of displayed elements while operating system is running at the touch input device 102. Also for descriptive purposes, FIG. 1 includes outlines of touch input that may be detected by the touch sensor 106 when a user is touching the touch sensitive display 104 utilizing a right hand. As illustrated in the example, touch area 130 is finger 1 of a right hand, touch area 132 is finger 2 of a right hand, touch area 134 is finger 3 of a right hand, touch area 134 is finger 4 of a right hand, and touch area 136 is finger 5 of a right hand. According to the illustrated example, finger 2 is touching the touch sensitive display 104 to create the second touch area 132 and fingers 1, 3, 4, and 5 are hovering over the touch sensitive display 104 to create first touch area 130, third touch area 134, fourth touch area 136, and fifth touch area 138.

FIG. 2 is a block diagram of an example implementation of the gesture handler 108 of FIG. 1. The example gesture handler 108 includes an example sensor interface 202, an example trainer 204, an example training datastore 206, an example identifier 208, an example gesture detector 210, an example an example gesture datastore 212, and an example system interface 214.

The example sensor interface 202 interfaces with the example touch sensor 106 to receive information about touches and/or hovers on the example touch sensitive display 104. The example sensor interface 202 transfers information about touches/hovers to the example trainer 204 and/or the example identifier 208.

The example trainer 204 collects information about touches/hovers to train a model or other identification tool to improve the ability of the gesture handler 108 to identify fingers for touches/hovers on the touch sensitive display 104. The example trainer 204 stores training data (e.g., a trained model) in the example training datastore 206. For example, the trainer 204 may prompt a user (e.g., present a display that asks a user to place finger(s) over and/or on the touch sensitive display 104) and may record the touch information and/or a finger(s) identification from the identifier 208. The recorded information may be used to train a model, identifier, etc. (e.g., a machine learning model) that is transferred to the identifier 208 for use in identifying finger(s).

The example training datastore 206 is a database for storing training/identification data. Alternatively, the training datastore 206 may be any other type of data storage (e.g., a file, a collection of files, a hard drive, a memory, etc.).

The example identifier 208 identifies the finger(s) associated with a touch/hover. According to the illustrated example, the identifier 208 identifies fingers by analyzing the relative locations of all detected touches/hovers to identify the finger(s) associated with the touches/hovers. For example, when a single hand is over the display during a touch, the five fingers may be identified based on the relative locations of the five appearing touches/hovers. The thumb may be identified by the relative rotation of the touch/hover of the thumb relative to the four fingers. Additionally or alternatively, a model may be utilized to identify the data based on locally trained or preinstalled training. The identifier 208 additionally determines whether each finger is touching or hovering. For example, the identifier 208 may determine that finger 2 is touching the display because the touch intensity of finger 2 is the strongest (e.g., creates the strongest disruption of a capacitive field of the touch sensitive display 104). The example identifier 208 transfers the identification of finger(s) and the finger(s) status (e.g., touching, hovering, etc.) to the example gesture detector 210.

The example gesture detector 210 analyzes touch/hover data received from the identifier 208 to detect gestures. As used herein, a gesture is any action performed by the touches/hovers. For example, a gesture may be a single touch/tap, a double touch/tap, a swipe, a pinch, a drag, etc. Thus, the gesture detector 210 may analyze multiple touches/hovers and/or touches/hovers over a period of time. Once the gesture detector 210 identifies a gesture, the gesture detector 210 determines an action associated with the gesture based on the finger(s) used for the gesture.

The example gesture detector queries the example gesture datastore 212 with information about the gesture (e.g., the finger(s) used, the gesture type, and/or the target of the gesture (e.g., the application to which the gesture is targeted)). According to the illustrated example, the action associated with a gesture depends on the finger(s) used for the gesture. For example, a first action may be performed for a gesture performed using finger 1 and a second action may be performed the same gesture performed using finger 2. For example, the same gesture (e.g., a tap on a button) may trigger different actions depending on the finger(s) used (e.g., tapping the button with finger 1 may trigger moving forward on a form and tapping with finger 2 may trigger moving backward on a form). The action for a gesture may additionally depend on the target of the gesture (e.g., the application, the user interface element, etc.).

In some examples, performing a pinch-in using finger 1 and finger 2 causes zooming in, performing a pinch-out using finger 1 and finger 2 causes zooming out, performing a pinch-in using finger 1 and finger 3 causes an application to be minimized, and performing a pinch-out using finger 1 and finger 3 causes an application to be maximized.

In some examples, tapping the screen with finger 2 triggers a left click action (e.g., the same action as clicking the left button of a mouse) and tapping the screen with finger 3 triggers are right click action.

In some examples, in an application that supports drawing, underlining, highlighting, handwriting, etc., different fingers may be associated with different colors (e.g., dragging with finger 2 creates a red line and dragging with finger 3 creates a blue line), different line formats (e.g., line weights, dashed lines vs. solid lines, etc.), use of different drawing tools, etc.

In some examples, multiple screens may be linked and a flick of one finger on an icon or widget may have the program open up on a different screen in the direction of the flick. Another finger may be used to send the program or data to the Recycle bin.

In some examples, touching a screen with different fingers (e.g., increasing from fingers 1 to 5 or decreasing from fingers 5 to 1, or any subset of increasing or decreasing) can trigger increasing a value or decreasing a value (e.g., increasing/decreasing a system setting such as volume or brightness, incrementing/decrementing a number, etc. For example, a single tap with finger 2 of the right hand may increase the volume by 5 units. A tap of finger 2 of the left hand may increase the brightness by 5 units. A tap with finger 3 on either hand may increase the respective property by 10 units and so on.

The gesture datastore 212 of the illustrated example is a database of rules that associate gestures with actions. Alternatively, the gesture datastore 212 may be any other type of data storage (e.g., a file, a collection of files, a hard drive, a memory, etc.). The gesture datastore 212 may alternatively or additionally store any other type of association of gestures and actions. For example, instead of rules, the associations of gestures and actions may be stored in a table, stored as settings, etc.

The system interface 214 interfaces with the example operating system 110 to transfer the action(s) determined by the example gesture detector 210 to an application and/or the example operating system 110.

While an example manner of implementing the gesture handler 108 of FIG. 1 is illustrated in FIG. 2, one or more of the elements, processes and/or devices illustrated in FIG. 1 may be combined, divided, re-arranged, omitted, eliminated and/or implemented in any other way. Further, the example sensor interface 202, the example trainer 204, the example identifier 208, the example gesture detector 210, the example system interface 214 and/or, more generally, the example gesture detector 108 of FIG. 1 may be implemented by hardware, software, firmware and/or any combination of hardware, software and/or firmware. Thus, for example, any of the example sensor interface 202, the example trainer 204, the example identifier 208, the example gesture detector 210, the example system interface 214 and/or, more generally, the example gesture detector 108 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example sensor interface 202, the example trainer 204, the example identifier 208, the example gesture detector 210, the example system interface 214 and/or, more generally, the example gesture detector 108 of FIG. 1 is/are hereby expressly defined to include a non-transitory computer readable storage device or storage disk such as a memory, a digital versatile disk (DVD), a compact disk (CD), a Blu-ray disk, etc. including the software and/or firmware. Further still, the example gesture detector 108 may include one or more elements, processes and/or devices in addition to, or instead of, those illustrated in FIG. 2, and/or may include more than one of any or all of the illustrated elements, processes and devices.

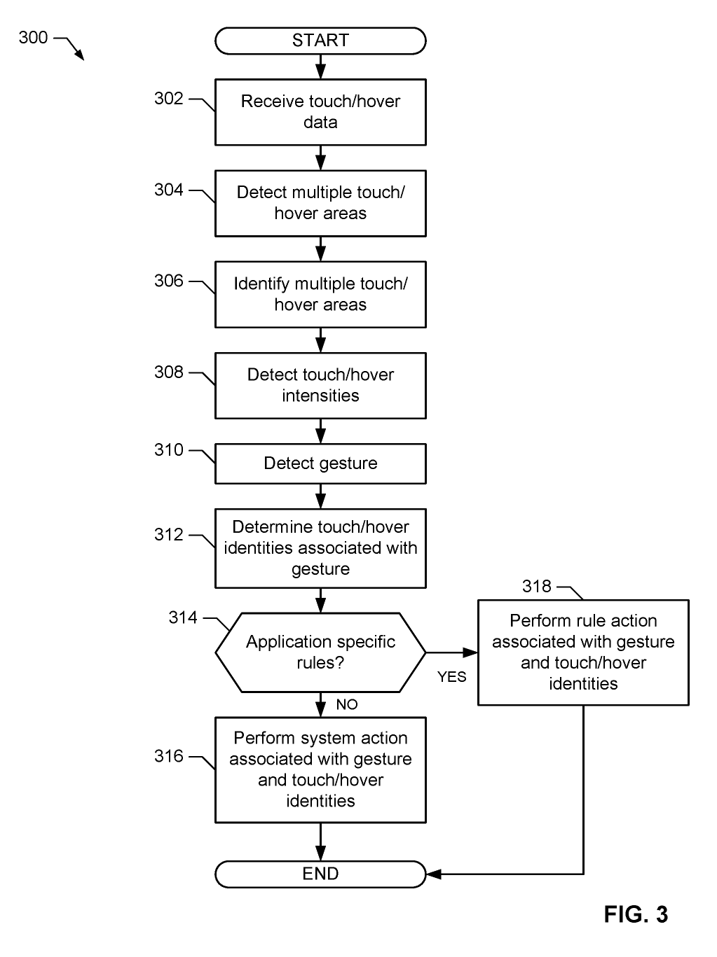

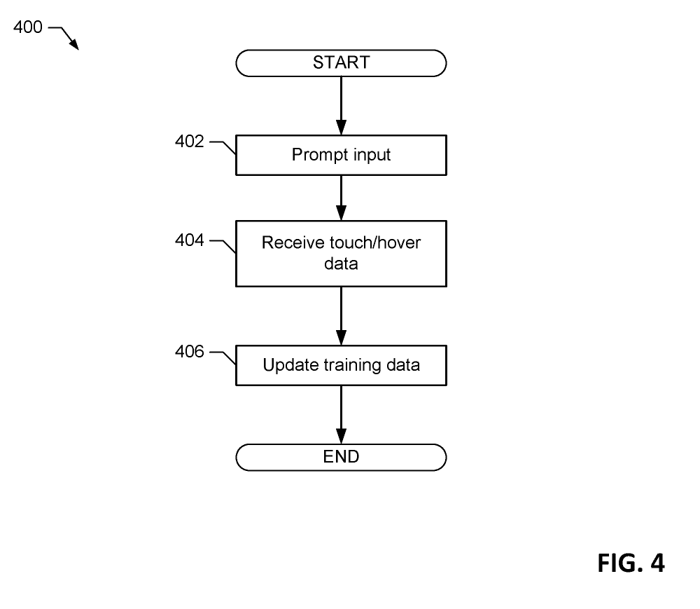

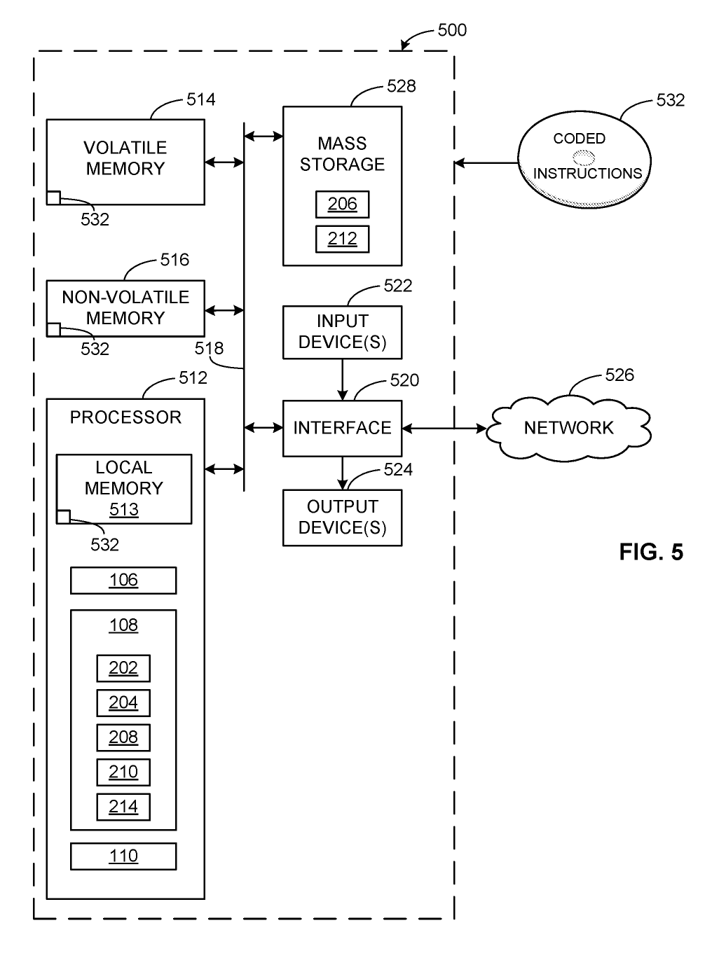

Flowcharts representative of example machine readable instructions for implementing the gesture detector 108 are shown in FIGS. 3-4. In the examples, the machine readable instructions comprise a program for execution by a processor such as the processor 512 shown in the example processor platform 500 discussed below in connection with FIG. 5. The program may be embodied in software stored on a non-transitory computer readable storage medium such as a CD-ROM, a floppy disk, a hard drive, a digital versatile disk (DVD), a Blu-ray disk, or a memory associated with the processor 512, but the entire program and/or parts thereof could alternatively be executed by a device other than the processor 512 and/or embodied in firmware or dedicated hardware. Further, although the example programs are described with reference to the flowcharts illustrated in FIGS. 3-4, many other methods of implementing the example gesture detector 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example processes of FIGS. 3-4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

The program 300 of FIG. 3 begins when the example sensor interface 202 receives touch/hover data from the example touch sensor 106 (block 302). The example identifier 208 detects the multiple touch/hover areas (block 304). For example, the identifier 208 may determine that there are multiple discrete touch/hover areas contained in the received touch/hover data. The example identifier 208 identifies the finger(s) associated with the multiple touch/hover areas (block 306). The example identifier 208 also determines the intensities of the identified touch/hover areas (block 308). For example, the identifier 208 may determine that there are one or more touches/hovers that are of greater intensity than the other touches/hovers and, thus, are the primary touches performing a gesture. For example, the identifier 208 may determine the force of a touch, a distinct of a hover from the touch sensitive display 104, or any other characteristic or data indicative of such characteristics.

The example gesture detector 210 determines a gesture that has been performed (e.g., a swipe, a tap, a pinch, etc.) (block 310). The gesture detector 210 determines the identities of the finger(s) that are associated with the gesture (block 312). The gesture detector 210 may additionally consider other characteristics of the touches/hovers. For example, the gesture detector 210 may analyze the identifies of the fingers used for the gesture, the identities of the fingers not-used for the gesture, the strength of a touch, the distance of a hover, etc. For example, a gesture may be comprised of an action perform by a finger(s) in touch with the touch sensitive display 104 and a finger(s) having a hover distance greater than (or less than) a threshold. For example, swiping with a first finger while holding a second finger (e.g., an adjacent finger) more than a threshold distance from the touch sensitive display 104 may be a first gesture/action and swiping with a first finger while holding a second finger (e.g., an adjacent finger) less than the threshold distance from the touch sensitive display 104 may be a second gesture/action.

The gesture detector 210 determines if there are any application specific rules in the gesture datastore 212 associated with the gesture and the application targeted with the gesture (block 314). When there are no application specific rules, the gesture detector transmits, via the system interface 214, the system action associated with the gesture and the identities of the finger(s) performing the gesture to the operating system 110 (block 316). When there are application specific rules, the gesture detector transmits, via the system interface 214, the application specific action associated with the gesture and the identities of the finger(s) performing the gesture to the operating system 110 (block 318).

The program 400 of FIG. 4 may be performed to train the gesture handler 108 for identifying the finger(s) associated with a gesture. The program 400 begins when training is initiated. For example, training may be initiated at the request of a user, may be initiated automatically, may be initiated when incorrect identification is detected, etc. The example trainer 204 prompts the user to touch/hover over the touch sensitive display 104 in a particular way (block 402). For example, the trainer 204 may prompt the user to touch the touch sensitive display 104 with finger 2 of the right hand while fingers 1 and 3-5 hover. When the user follows the direction, the sensor interface 202 receives touch/hover data (block 404). The trainer 204 updates the training data in the training datastore 206 (block 406). For example, the trainer 204 may update a model based on the input, may update a machine learning system based on the input, etc.

FIG. 5 is a block diagram of an example processor platform 500 capable of executing the instructions of FIGS. 3-4 to implement the gesture detector 58 of FIGS. 1 and/or 2. The processor platform 500 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 500 of the illustrated example includes a processor 512. The processor 512 of the illustrated example is hardware. For example, the processor 512 can be implemented by one or more integrated circuits, logic circuits, microprocessors or controllers from any desired family or manufacturer. The hardware processor may be a semiconductor based (e.g., silicon based) device. In this example, the processor 512 implements sensor interface 202, trainer 204, identifier 208, gesture detector 210, and system interface 214.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, one or more input devices 522 are connected to the interface circuit 520. The input device(s) 522 permit(s) a user to enter data and/or commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes one or more mass storage devices 528 for storing software and/or data. Examples of such mass storage devices 528 include floppy disk drives, hard drive disks, compact disk drives, Blu-ray disk drives, RAID systems, and digital versatile disk (DVD) drives. The example mass storage device 528 stores the training datastore 206 and gesture datastore 212.

The coded instructions 532 of FIGS. 3-4 may be stored in the mass storage device 528, in the volatile memory 514, in the non-volatile memory 516, and/or on a removable tangible computer readable storage medium such as a CD or DVD.

Example methods, apparatus, systems and articles of manufacture to detect anomalies in electronic data are disclosed herein. Further examples and combinations thereof include the following.

Example 1 is an apparatus to trigger an action based on a gesture, the apparatus comprising: a touch sensitive display, a touch sensor to detect touches and hovers associated with the touch sensitive display, and a gesture handler including: an identifier to identify fingers associated with the touches and hovers, and a gesture detector to determine a gesture associated with the touches and hovers and determine an action associated with the gesture and the identified fingers.

Example 2 includes the apparatus as defined in example 1, wherein the gesture handler includes a system interface to transmit the action to an operating system of the apparatus.

Example 3 includes the apparatus as defined in example 1 or example 2, wherein the gesture detector determines a first action associated with the gesture when a first finger is identified for the gesture and a second action associated with the gesture when a second finger is identified for the gesture.

Example 4 includes the apparatus as defined in example 3, wherein the first action is a left mouse click and the second action is a right mouse click.

Example 5 includes the apparatus as defined in example 3, wherein the first action is drawing with a first color and the second action is drawing with a second color.

Example 6 includes the apparatus as defined in example 3, wherein the first action is opening an application on a first screen and the second action is opening the application on a second screen.

Example 7 includes the apparatus as defined in example 3, wherein the first action is changing a first setting of a system and the second action is changing a second setting of the system.

Example 8 is a non-transitory computer readable medium comprising instructions that, when executed, cause a machine to at least: detect touches and hovers associated with a touch sensitive display, identify fingers associated with the touches and hovers, determine a gesture associated with the touches and hovers, and determine an action associated with the gesture and the identified fingers.

Example 9 includes the non-transitory computer readable medium as defined in example 8, wherein the instructions, when executed, cause the machine to transmit the action to an operating system of the apparatus.

Example 10 includes the non-transitory computer readable medium as defined in example 8 or example 9, wherein the instructions, when executed, cause the machine to determine a first action associated with the gesture when a first finger is identified for the gesture and a second action associated with the gesture when a second finger is identified for the gesture.

Example 11 includes the non-transitory computer readable medium as defined in example 10, wherein the first action is a left mouse click and the second action is a right mouse click.

Example 12 includes the non-transitory computer readable medium as defined in example 10, wherein the first action is drawing with a first color and the second action is drawing with a second color.

Example 13 includes the non-transitory computer readable medium as defined in example 10, wherein the first action is opening an application on a first screen and the second action is opening the application on a second screen.

Example 14 includes the non-transitory computer readable medium as defined in example 10, wherein the first action is changing a first setting of a system and the second action is changing a second setting of the system.

Example 15 is a method to trigger an action based on a gesture, the method comprising: detecting touches and hovers associated with a touch sensitive display, identifying fingers associated with the touches and hovers, determining a gesture associated with the touches and hovers, and determining an action associated with the gesture and the identified fingers.

Example 16 includes the method as defined in example 15, further including transmitting the action to an operating system of the apparatus.

Example 17 includes the method as defined in example 15 or example 16, further including determining a first action associated with the gesture when a first finger is identified for the gesture and a second action associated with the gesture when a second finger is identified for the gesture.

Example 18 includes the method as defined in example 17, wherein the first action is a left mouse click and the second action is a right mouse click.

Example 19 includes the method as defined in example 17, wherein the first action is drawing with a first color and the second action is drawing with a second color.

Example 20 includes the method as defined in example 17, wherein the first action is opening an application on a first screen and the second action is opening the application on a second screen.

Example 21 includes the method as defined in example 17, wherein the first action is changing a first setting of a system and the second action is changing a second setting of the system.

Example 22 is an apparatus to trigger an action based on a gesture, the apparatus comprising: an identifier to identify fingers associated with touches and hovers associated with a touch sensitive display, and a gesture detector to determine a gesture associated with the touches and hovers and determine an action associated with the gesture and the identified fingers.

Example 23 includes the apparatus as defined in example 22, further including a system interface to transmit the action to an operating system of the apparatus.

Example 24 includes the apparatus as defined in example 22 or example 23, wherein the gesture detector determines a first action associated with the gesture when a first finger is identified for the gesture and a second action associated with the gesture when a second finger is identified for the gesture.

Example 25 includes the apparatus as defined in example 24, wherein the first action is a left mouse click and the second action is a right mouse click.

Example 26 includes the apparatus as defined in example 24, wherein the first action is drawing with a first color and the second action is drawing with a second color.

Example 27 includes the apparatus as defined in example 24, wherein the first action is opening an application on a first screen and the second action is opening the application on a second screen.

Example 28 includes the apparatus as defined in example 24, wherein the first action is changing a first setting of a system and the second action is changing a second setting of the system.

Example 29 is an apparatus to trigger an action based on a gesture, the apparatus comprising: means for detecting touches and hovers associated with a touch sensitive display, means for identifying fingers associated with the touches and hovers, means for determining a gesture associated with the touches and hovers, and means for determining an action associated with the gesture and the identified fingers.

Example 30 includes the apparatus as defined in example 29, further including means for transmitting the action to an operating system of the apparatus.

Example 31 is a system to trigger an action based on a gesture, the system comprising: a touch sensitive display, an operating system associated with an executing application, a touch sensor to detect touches and hovers associated with the touch sensitive display, and a gesture handler including: an identifier to identify fingers associated with the touches and hovers; and a gesture detector to determine a gesture associated with the touches and hovers and determine an action for the operating system, the associated with the gesture and the identified fingers.

Example 32 includes the system as defined in claim 31, wherein the gesture handler including a system interface to transmit the action to the operating system to cause the action to be performed with the executing application.

From the foregoing, it will be appreciated that example methods, apparatus and articles of manufacture have been disclosed that facilitate near manners of interacting with a computing device having a touch sensitive display. In some examples, distinct user input information may be facilitated without adding additional user input devices. Touch input may convey distinct information to the computing device without the need for physical or virtual switches by detecting distinctions in the identity of the finger(s) used to provide input, the strength of touch, the distance of hovering, etc.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus to trigger an action based on a gesture, the apparatus comprising:
a touch sensitive display;
a touch sensor to detect touches and hovers associated with the touch sensitive display; and
a gesture handler including:
an identifier to identify fingers associated with the touches and hovers; and
a gesture detector to determine a gesture associated with the touches and hovers and determine an action associated with the gesture and the identified fingers.

2. An apparatus as defined in claim 1, wherein the gesture handler includes a system interface to transmit the action to an operating system of the apparatus.

3. An apparatus as defined in claim 1, wherein the gesture detector determines a first action associated with the gesture when a first finger is identified for the gesture and a second action associated with the gesture when a second finger is identified for the gesture.

4. An apparatus as defined in claim 3, wherein the first action is a left mouse click and the second action is a right mouse click.

5. An apparatus as defined in claim 3, wherein the first action is drawing with a first color and the second action is drawing with a second color.

6. An apparatus as defined in claim 3, wherein the first action is opening an application on a first screen and the second action is opening the application on a second screen.

7. An apparatus as defined in claim 3, wherein the first action is changing a first setting of a system and the second action is changing a second setting of the system.

8. A non-transitory computer readable medium comprising instructions that, when executed, cause a machine to at least:
detect touches and hovers associated with a touch sensitive display;
identify fingers associated with the touches and hovers;
determine a gesture associated with the touches and hovers; and
determine an action associated with the gesture and the identified fingers.

9. A non-transitory computer readable medium as defined in claim 8, wherein the instructions, when executed, cause the machine to transmit the action to an operating system of the machine.

10. A non-transitory computer readable medium as defined in claim 8, wherein the instructions, when executed, cause the machine to determine a first action associated with the gesture when a first finger is identified for the gesture and a second action associated with the gesture when a second finger is identified for the gesture.

11. A non-transitory computer readable medium as defined in claim 10, wherein the first action is a left mouse click and the second action is a right mouse click.

12. A non-transitory computer readable medium as defined in claim 10, wherein the first action is drawing with a first color and the second action is drawing with a second color.

13. A non-transitory computer readable medium as defined in claim 10, wherein the first action is opening an application on a first screen and the second action is opening the application on a second screen.

14. A non-transitory computer readable medium as defined in claim 10, wherein the first action is changing a first setting of a system and the second action is changing a second setting of the system.

15. A method to trigger an action based on a gesture, the method comprising:
detecting touches and hovers associated with a touch sensitive display;
identifying fingers associated with the touches and hovers;
determining a gesture associated with the touches and hovers; and
determining an action associated with the gesture and the identified fingers.

16. A method as defined in claim 15, further including transmitting the action to an operating system of the machine.

17. A method as defined in claim 15, further including determining a first action associated with the gesture when a first finger is identified for the gesture and a second action associated with the gesture when a second finger is identified for the gesture.

18. A method as defined in claim 17, wherein the first action is a left mouse click and the second action is a right mouse click.

19. A method as defined in claim 17, wherein the first action is drawing with a first color and the second action is drawing with a second color.

20. A method as defined in claim 17, wherein the first action is opening an application on a first screen and the second action is opening the application on a second screen.

21. A method as defined in claim 17, wherein the first action is changing a first setting of a system and the second action is changing a second setting of the system.

22. An apparatus to trigger an action based on a gesture, the apparatus comprising:
an identifier to identify fingers associated with touches and hovers associated with a touch sensitive display; and
a gesture detector to determine a gesture associated with the touches and hovers and determine an action associated with the gesture and the identified fingers.

23. An apparatus as defined in claim 22, further including a system interface to transmit the action to an operating system of the apparatus.

24. An apparatus as defined in claim 22, wherein the gesture detector determines a first action associated with the gesture when a first finger is identified for the gesture and a second action associated with the gesture when a second finger is identified for the gesture.

25. An apparatus as defined in claim 24, wherein the first action is a left mouse click and the second action is a right mouse click.
